(19) United States
(12) Patent Application Publication
(10) Pub. No.: US 2005/0228982 A1
(43) Pub. Date: Oct. 13, 2005

(54) Data communication system control method, data communication system, and information processing apparatus

(75) Inventors: Kojiro Nakayama, Yokohama (JP); Masahiro Himaki, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/996,974

(22) Filed: Nov. 23, 2004

(30) Foreign Application Priority Data
Apr. 9, 2004 (JP) 2004-115455

(51) Int. Cl. H04L 9/00

(52) U.S. Cl. 713/150

(57) ABSTRACT

Efficient management of security policies is achieved in a data communication system. In a second information processing apparatus, a general-purpose policy is managed that includes an individual policy that is a security policy applied to data transmitted from a first information processing apparatus to the second information processing apparatus. The second information processing apparatus generates an individual policy based on an individual policy request transmitted from the first information processing apparatus and on the general-purpose policy, transmitting the individual policy to the first information processing apparatus. The first information processing apparatus subjects data to be transmitted to a security processing in conformity with the received individual policy.

### CROSS-REFERENCE TO RELATED APPLICATIONS

The present application claims priority upon Japanese Patent Application No. 2004-115455 filed on Apr. 9, 2004, which is herein incorporated by reference.

### BACKGROUND OF THE INVENTION

1. Field of the Invention

The present invention relates generally to a technique for managing security policies in a data communication system, and, more particularly, to a data communication system control method, a data communication system and an information processing apparatus.

2. Description of the Related Art

XML (Extensible Markup Language), one of the markup languages recommended by W3C (World Wide Web Consortium), a standardization organization, is drawing attention in recent years. XML is widely used as a data format for exchanging data between a plurality of information processing apparatuses connected by the Internet, a LAN (Local Area Network) or other networks. “XML Encryption Syntax and Processing (hereinafter referred to as “XML encryption”)”, also recommended by W3C, defines methods for encrypting the whole or part of XML documents. On the other hand, “XML-Signature Syntax and Processing (hereinafter referred to as “XML signature”)”, also recommended by W3C, defines methods for signing the whole or part of XML documents.

When XML-described data is exchanged between different information processing apparatuses, XML encryption or XML signature is occasionally used in order to ensure security during communication. In this case, the data sender performs security processings on the data to be transmitted using XML encryption or XML signature before transmitting the data to the data receiver. This enables safe communication ensuring integrity and confidentiality of XML data.

When XML data is exchanged among a number of information processing apparatuses, security-related requirements occasionally exist for the data to be transmitted. Among security-related requirements are the areas to be encrypted, the areas to be signed, the encryption algorithm used and the signature algorithm used. These requirements are called security policies. Among methods for expressing security policies is the method shown in e.g., Microsoft, “Web Services Security Policy Language (WS-SecurityPolicy)”, [online], Dec. 18, 2002, [searched Feb. 2, 2004], Internet <URL:http://msdn.microsoft.com/ws/2002/12/ws-security-policy/>. The data sender can find out what kind of security processings to perform by acquiring the security policies prior to data transmission.

Management of the security policies becomes complicated when data is exchanged among a number of information processing apparatuses. For example, when data is sent to a certain information processing apparatus from a plurality of information processing apparatuses, the security policies to be applied to the individual information processing apparatuses transmitting data may vary. In this case, however, management is required of the security policies to be applied for each information processing apparatus. On the other hand, when data is sent from one information processing apparatus to another, data is occasionally sent by way of an information processing apparatus different from these information processing apparatuses. In this case, data must be transmitted in a manner compatible with the security policies demanded of the information processing apparatus by way of which the data is sent, and setting and managing such security policies imposes a considerable burden of management.

### SUMMARY OF THE INVENTION

In light of the above, it is an object of the present invention to provide a data communication system control method, a data communication system and an information processing apparatus, capable of efficiently managing security policies.

In order to attain the above object, according to a major aspect of the present invention there is provided a control method of a data communication system performing data communication in conformity with a security policy, the data communication system including a first information processing apparatus with a first CPU and a first memory and a second information processing apparatus with a second CPU and a second memory connected to the first information processing apparatus so as to be able to communicate therewith, wherein the first information processing apparatus includes an individual policy request unit and a security processing unit implemented through execution of a program stored in the first memory by the first CPU, and wherein the second information processing apparatus includes an individual policy response unit implemented through execution of a program stored in the second memory by the second CPU, the control method comprising the steps of the second information processing apparatus storing a general-purpose policy including an individual policy that is a security policy applied to data transmitted from the first information processing apparatus to the second information processing apparatus; the individual policy request unit transmitting to the second information processing apparatus an individual policy request including extractive information on the individual policy from the general-purpose policy; the second information processing apparatus receiving the individual policy request; the individual policy response unit generating the individual policy from the general-purpose policy based on the extractive information included in the received individual policy request; the second information processing apparatus transmitting to the first information processing apparatus the individual policy generated by the individual policy response unit; the first information processing apparatus receiving the individual policy; and the security processing unit subjecting the data to a security processing in conformity with the received individual policy when the data is transmitted from the first information processing apparatus to the second information processing apparatus.

According to the present invention, security policies can be efficiently managed in a data communication system.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 is a view showing an overall configuration of a data communication system 1 described as a first embodiment of the present invention;

FIG. 2 is a view showing an example of a hardware configuration of computers used as information processing apparatuses described as an embodiment of the present invention;

FIG. 3A is a view showing the functions implemented and the data stored in a first information processing apparatus 101 described in the first embodiment of the present invention;

FIG. 3B is a view showing the functions implemented and the data stored in a second information processing apparatus 111 described in the first embodiment of the present invention;

FIG. 4 is a view describing processings performed when operational data 105 is actually transmitted from the first information processing apparatus 101 to the second information processing apparatus 111, both described in the first embodiment of the present invention;

FIG. 5 is a view showing an example of an individual policy request written in XML format described in the first embodiment of the present invention;

FIG. 6 is a view showing an example of a general-purpose policy 115 stored in the second information processing apparatus 111 described in the first embodiment of the present invention;

FIG. 7 is a view showing an example of operational data described in the first embodiment of the present invention;

FIGS. 8A and 8B are views showing examples of an individual policy described in the first embodiment of the present invention;

FIG. 9 is a view showing an example of the contents of operational data following the security processings described in the first embodiment of the present invention;

FIG. 10 is a view showing an example of a role mapping table described in a second embodiment of the present invention;

FIG. 11 is a view showing an example of a general-purpose policy described in the second embodiment of the present invention;

FIG. 12 is a view showing an example of an individual policy described in the second embodiment of the present invention;

FIG. 13 is a view showing an overall configuration of the data communication system 1 described in a third embodiment of the present invention;

FIG. 14A is a view showing the functions implemented and the data stored in a first information processing apparatus 131 described in the third embodiment of the present invention;

FIG. 14B is a view showing the functions implemented and the data stored in a second information processing apparatus 141 described in the third embodiment of the present invention;

FIG. 15A is a view showing the functions implemented and the data stored in a third information processing apparatus 151 described in the third embodiment of the present invention;

FIG. 15B is a view showing the functions implemented and the data stored in a fourth information processing apparatus 161 described in the third embodiment of the present invention;

FIG. 16 is a view describing, in the third embodiment of the present invention, the processings performed when operational data from the first information processing apparatus 131 is transmitted to the third information processing apparatus 151 by way of the second information processing apparatus 141;

FIG. 17 is a view showing an example of a general-purpose policy 1552 described in the third embodiment of the present invention;

FIG. 18 is a view showing an example of a first individual policy generated by a first individual policy request and the general-purpose policy 1552 described in the third embodiment of the present invention; and

FIG. 19 is a view showing an example of a second individual policy generated by a second individual policy request and the general-purpose policy 1552 described in the third embodiment of the present invention.

### DETAILED DESCRIPTION OF THE INVENTION

<First Embodiment>

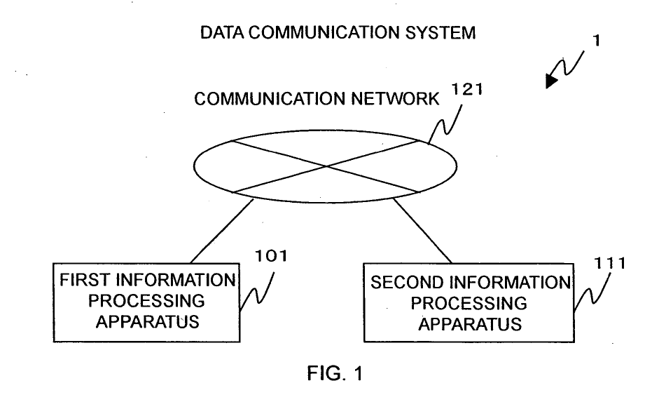

FIG. 1 shows an overall configuration of a data communication system 1 according to a first embodiment of the present invention. First and second information processing apparatuses 101 and 111 are connected via a communication network 121 so as to be able to communicate with each other. The communication network 121 is, for example, the Internet, a LAN (Local Area Network) or a WAN (Wide Area Network). The first and second information processing apparatuses 101 and 111 are computers such as personal computers, office computers or mainframes. The first and second information processing apparatuses 101 and 111 may also be mobile information terminals or PDAs (Personal Digital Assistants) with a capability to connect to the communication network 121.

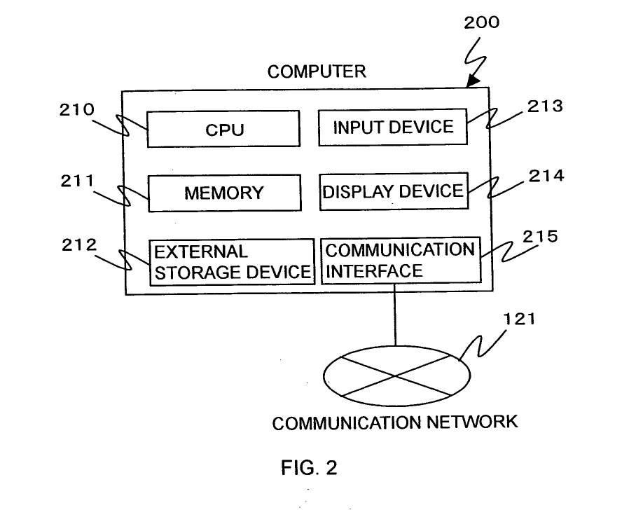

FIG. 2 shows an example of a hardware configuration of computers used as the first and second information processing apparatuses 101 and 111. A computer 200 is provided with a CPU (Central Processing Unit) 210, a memory 211, a main storage device made up of RAM, ROM, etc., an external storage device 212 such as a hard disk device, an input device 213 such as a keyboard or mouse, a display device 214 such as a display, and a communication interface 215 such as an NIC (Network Interface Card).

The relationship between the first and second information processing apparatuses 101 and 111 is that the first information processing apparatus 101 transmits data to the second information processing apparatus 111 via the communication network 121. Such a relationship can occur between computers installed at a data center, between computers on the Internet, between corporate-owned computers in intercorporate communications and so on. In the case of the relationship between a computer communicating with automatic teller machines provided at various locations for use in bank's online operations and that used in batch processing, data analysis and other operations, the former corresponds to the first information processing apparatus 101, and the latter to the second information processing apparatus 111. It is to be noted that the data transmitted from the first information processing apparatus 101 to the second information processing apparatus 111 is hereinafter referred to as “operational data”.

The operational data, transmitted from the first information processing apparatus 101 to the second information processing apparatus 111, is subjected to a security processing in conformity with a security policy. Here, the security processing refers to a processing such as XML encryption or XML signature, for example, when the operational data is written in XML. The security policy, applied to the operational data transmitted from the first information processing apparatus 101 to the second information processing apparatus 111, is determined in conformity with the relationship between the first information processing apparatus 101, a sender of the operational data, and the second information processing apparatus 111, a receiver thereof. That is, in the presence of a plurality of the first information processing apparatuses 101 transmitting the operational data to the second information processing apparatus 111, the security policies applied to the operational data is determined in conformity with the first information processing apparatuses 101. The respective security policies determined in conformity with the relationship between the first information processing apparatuses 101 and the second information processing apparatus 111 are hereinafter referred to as “individual policies”.

An individual policy is generated prior to transmission of the operational data from the first information processing apparatus 101 to the second information processing apparatus 111 as a result of transmission of an individual policy generation request (hereinafter referred to as “individual policy request”) from the first information processing apparatus 101 to the second information processing apparatus 111. The second information processing apparatus 111 stores a general-purpose policy that includes an individual policy determined in conformity with the relationship between the first information processing apparatuses 101 and the second information processing apparatus 111. The individual policy request, transmitted from the first information processing apparatus 101 to the second information processing apparatus 111, includes extractive information—information for extracting an individual policy from the general-purpose policy. The second information processing apparatus 111 generates an individual policy from the general-purpose policy based on this extractive information and transmits the generated individual policy to the first information processing apparatus 101.

Thus, the need for storing an individual policy in each of the first information processing apparatuses 101 is eliminated by generating an individual policy, applied to the operational data transmitted from the first information processing apparatuses 101 to the second information processing apparatus 111, based on the general-purpose policy managed in the second information processing apparatus 111. Besides, the security policies to be satisfied by each of the first information processing apparatuses 101 can be managed as a general-purpose policy in a unified manner, allowing efficient management of the security policies. Moreover, the security policies can be managed in a consistent manner in the system as a whole, allowing readily implementing a consistent arrangement for security policy management in a data communication system in which a plurality of information processing apparatuses communicate with each other.

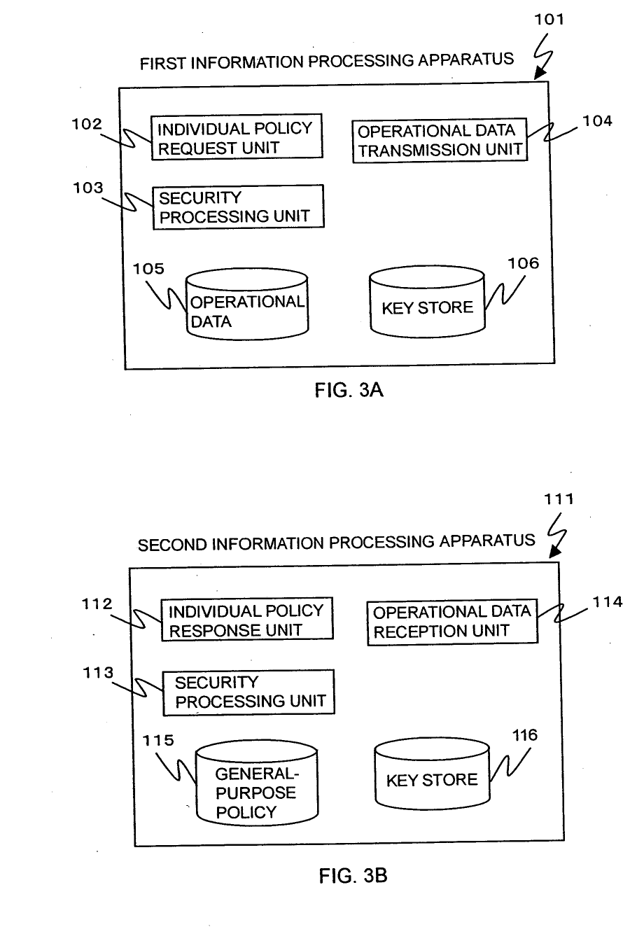

FIG. 3A shows, in relation to the aforementioned arrangement, the functions implemented and the data stored in the first information processing apparatus 101. It is to be noted that the functions shown in the figure are implemented by the hardware functions provided in the first information processing apparatus 101 and through execution of the stored programs called into the memory 211 by the CPU 210.

In FIG. 3A, an individual policy request unit 102 generates an individual policy request and transmits the request to the second information processing apparatus 111. The individual policy request unit 102 receives an individual policy transmitted from the second information processing apparatus 111. A security processing unit 103 subjects the operational data, transmitted from the first information processing apparatus 101 to the second information processing apparatus 111, to a security processing such as XML encryption or XML signature in conformity with the individual policy received by the individual policy request unit 102. An operational data transmission unit 104 subjects the operational data 105 to the security processing depending on the individual policy and transmits the operational data 105 subjected to the security processing to the second information processing apparatus 111. A key store 106 stores keys used for the security processings (e.g., secret and public keys in the public key encryption system).

FIG. 3B shows, in relation to the aforementioned arrangement, the functions implemented and the data stored in the second information processing apparatus 111. It is to be noted that the functions shown in the figure are implemented by the hardware functions provided in the second information processing apparatus 111 and through execution of the stored programs called into the memory 211 by the CPU 210.

In FIG. 3B, an individual policy request unit 112 receives an individual policy request transmitted from the first information processing apparatus 101, generates an individual policy from a general-purpose policy 115 based on extractive information contained in the received individual policy request, and transmits the generated individual policy to the first information processing apparatus 101. A security processing unit 113 subjects the operational data 105, transmitted from the first information processing apparatus 101, to a security processing such as decoding or verification. An operational data reception unit 114 receives the operational data 105 subjected to the security processing transmitted from the first information processing apparatus 101. A key store 116 stores keys used for decoding or verification of the operational data 105 (e.g., secret and public keys in the public key encryption system).

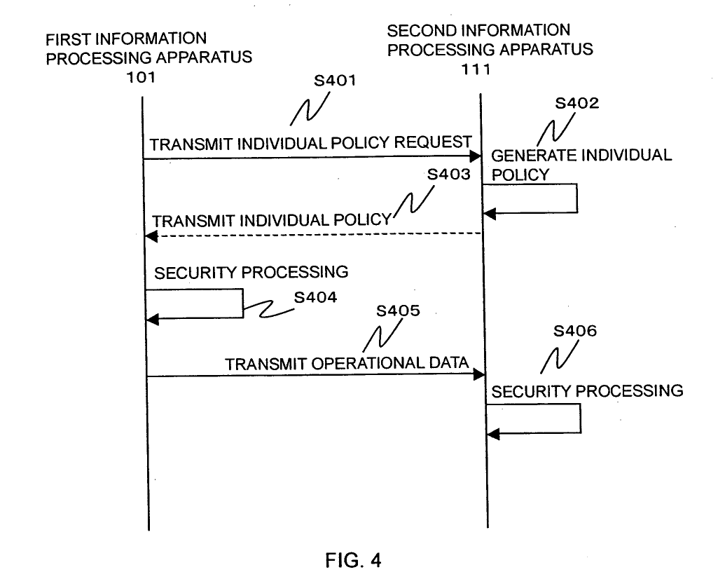

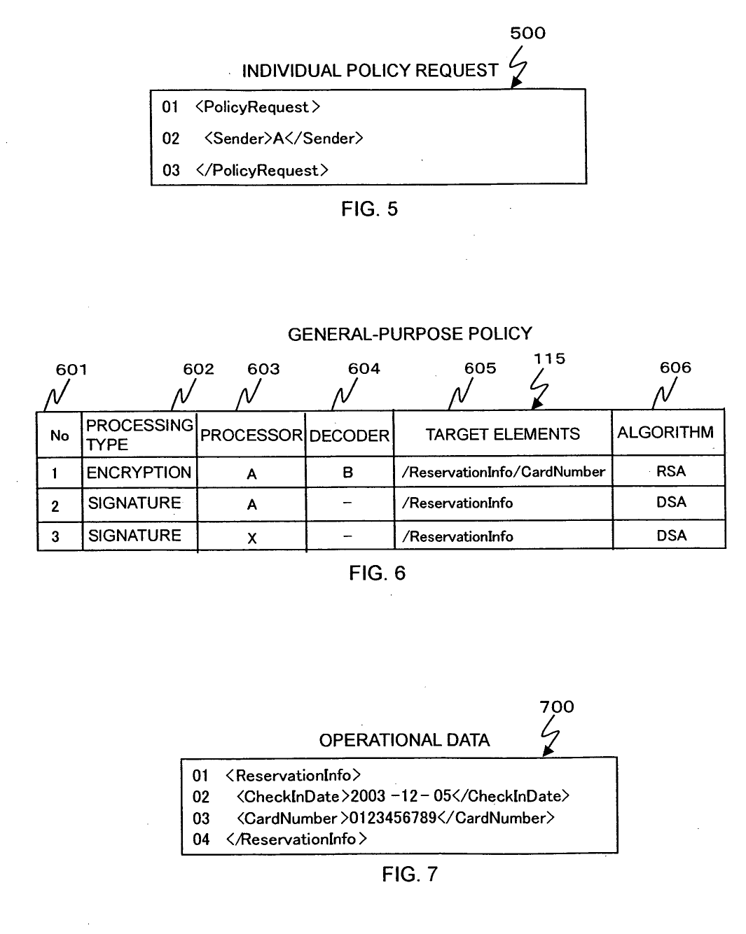

FIG. 4 is a view describing processings related to transmission of the operational data 105 from the first information processing apparatus 101 to the second information processing apparatus 111. In the transmission of the operational data 105, an individual policy request is first transmitted from the first information processing apparatus 101 to the second information processing apparatus 111 (S401). FIG. 5 shows an example of an individual policy request. It is to be noted that the individual policy request shown in FIG. 5 is written in XML format. It is also to be noted that the line numbers in the figure are assigned for convenience of description and that no line number display is included in the actual data.

Upon receiving the individual policy request, the second information processing apparatus 111 generates an individual policy based on the extractive information contained in the received individual policy request and the general-purpose policy 115 (S402). FIG. 6 shows an example of the general-purpose policy 115. In a No column 601, an identifier is written that is assigned for each line of data of the general-purpose policy 115 (hereinafter referred to as “policy expression”). In a processing type column 602, a security processing type is written. It is to be noted that in the present embodiment, XML encryption and XML signature are available as security processing types. In a processor column 603, the identifier of the first information processing apparatus 101 is written to which the security policy expressed by that policy expression is applied. The contents of a decoder column 604 are written only when “Encryption” is written in the processing type column 602, and the identifier of the second information processing apparatus 111 decoding the operational data 105 is written. In a target elements column 605, information is written, among that available in the operational data 105, which identifies the element to be subjected to a security processing. FIG. 6 is premised on the assumption that the operational data 105 is the data in XML format shown in FIG. 7. In the target elements column 605, a character string in XPath (XML Path Language) format is written in which the element names from the root element to the element to be processed are delimited by a delimiting character “/” as the information identifying the elements to be subjected to the security processing. In an algorithm column 606, an algorithm is written that is used for XML encryption or signature.

In the general-purpose policy 115 shown in FIG. 6, the policy expression in the first line declares that the data written in the target elements column 605, i.e., the contents of “CardNumber element”, the child element of “Reservation Info element” that is the root element of the operational data 105, should be encrypted by the first information processing apparatus 101 identified by “A” written in the processor column 603 using “RSA (Rivest-Shamir-Adleman Scheme)”, the algorithm written in the algorithm column 606, and that the operational data 105 should be decoded by the second information processing apparatus 111 identified by “B” written in the decoder column 604. On the other hand, the policy expression in the second line declares that the data written in the target elements column 605, i.e., the contents of “ReservationInfo element”, the root element of the operational data 105, should be signed by the first information processing apparatus 101 identified by “A” written in the processor column 603 using “DSA (Digital Signature Algorithm)”, the algorithm written in the algorithm column 606.

Further, the policy expression in the third line declares that the data written in the target elements column 605, i.e., the contents of “ReservationInfo element”, the root element of the operational data 105, should be signed by the first information processing apparatus 101 identified by an identifier “X”, using “DSA”, the algorithm written in the algorithm column 606.

Description will be given next of the processings (Step 402) related to generation of an individual policy performed in the second information processing apparatus 111, taking, as an example, the case in which an individual policy is generated based on the individual policy request shown in FIG. 5 and the general-purpose policy shown in FIG. 6.

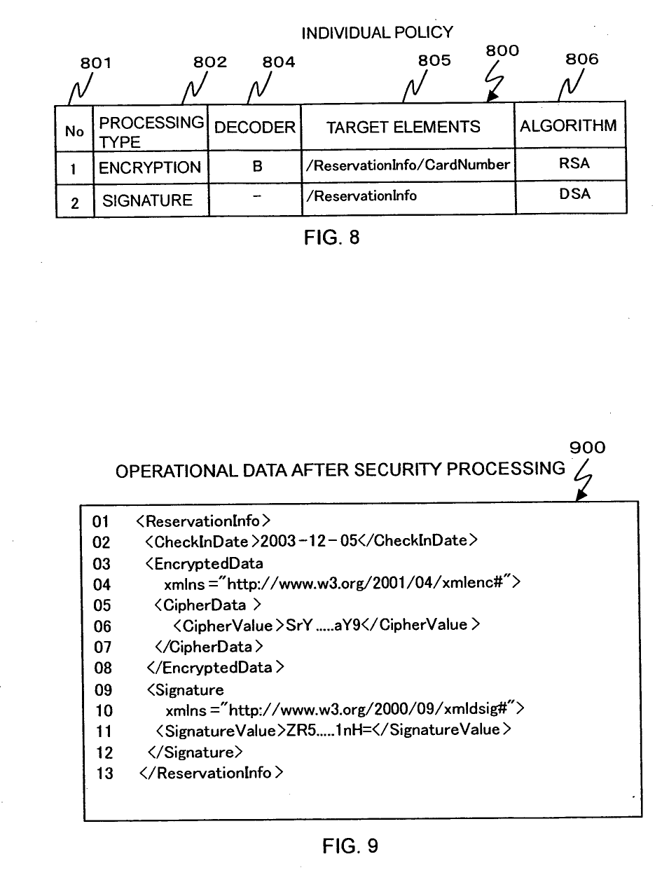

First, the individual policy response unit 112 first extracts, of the policy expressions included in the general-purpose policy 115, the expressions having the content of the processor column 603 matching with “A” written in “Sender element” in the second line of the individual policy request. Here, the individual policy response unit 112 extracts the policy expressions in the first and second lines. It is to be noted that in this case, “A” written in “Sender element” is the aforementioned extractive information for extracting an individual policy from the general-purpose policy 115. Next, the individual policy response unit 112 generates an individual policy from the extracted policy expressions in the first and second lines using the contents thereof excluding the content of the processor column 603. FIG. 8 shows an individual policy 800 generated in this manner. The individual policy response unit 112 transmits the generated individual policy to the first information processing apparatus 101 that transmitted the individual policy request, resulting in the individual policy being received by the first information processing apparatus 101 (S403). It is to be noted that while the above description applies to the case in which “A” is written in “Sender element” of the individual policy request, the individual policy shown in FIG. 8 is generated when “X” is written herein.

Next, the security processing unit 103 of the first information processing apparatus 101 subjects operational data 700 to security processings in conformity with the individual policy received (S404). The security processing unit 103 first subjects the operational data 700 to a security processing in conformity with the security policy in the first line of the individual policy 800. Here, the security processing unit 103 encrypts the contents of the elements identified by “/ReservationInfo/CardNumber” written in a target elements column 805 of the individual policy 800 in conformity with “RSA”, the algorithm written in an algorithm column 806 using the public key of the information processing apparatus corresponding to the identifier written in a decoder column 804. Next, the security processing unit 103 subjects the operational data 700 to a security processing in conformity with the security policy in the second line of the individual policy 800. Here, the security processing unit 103 signs the contents of the elements identified by “/ReservationInfo” written in the target elements column 805 of the individual policy 800 in conformity with “DSA”, the algorithm written in the algorithm column 806 using the secret key of the first information processing apparatus 101.

FIG. 9 shows an example of the operational data following the above-described security processings. In “EncryptedData element” written from lines 3 to 8, the data (encrypted data) is written that was generated when the security processing unit 103 encrypted the contents of “CardNumber element.” In “Signature element” written in lines 9 to 12, the signature value is written that was generated when the security processing unit 103 signed “ReservationInfo element.”

Operational data 900 following the security processings is transmitted to the second information processing apparatus 111 by the operational data transmission unit 104, resulting in the data being received by the operational data reception unit 114 of the second information processing apparatus 111 (S405). The security processing unit 113 of the second information processing apparatus 111 performs security processings such as decoding and verification on the operational data 900 using the key stored in the key store 116 (S406).

It is to be noted that while in the above description, the assigned identifiers are written for each of the information processing apparatuses in the processor column 603 and the decoder column 604 of the general-purpose policy 115 shown in FIG. 6, individual policies may be configured to be generated, if the information processing apparatuses are managed through classification by group, based on the information identifying the group written in the individual policy request by writing an identifier identifying the group in the processor column 603. On the other hand, the contents of a policy expression are not limited to those shown in FIG. 6. Other various information related to the security policy such as a key data size can be used as the contents of a policy expression.

While in the above description, an individual policy is generated by the second information processing apparatus 111, a general-purpose policy may be, for example, transmitted from the second information processing apparatus 111 to the first information processing apparatus 101 in response to a request from the first information processing apparatus 101, thus generating an individual policy in the first information processing apparatus 101 using the general-purpose policy. For example, in this case, the first information processing apparatus 101 stores extractive information, thus allowing the security processing unit 113 to generate an individual policy from the general-purpose policy based on the extractive information. This prevents an increase in the processing burden on the second information processing apparatus 111 caused by the processings for generating an individual policy.

<Second Embodiment>

Description will be given next of the data communication system 1 according to a second embodiment. While being basically the same in configuration as that of the first embodiment, the data communication system 1 described as the second embodiment differs from that of the first embodiment in that extraction of an individual policy based on an individual policy request and a general-purpose policy can be conducted based on roles—information indicating the roles of the respective information processing apparatuses.

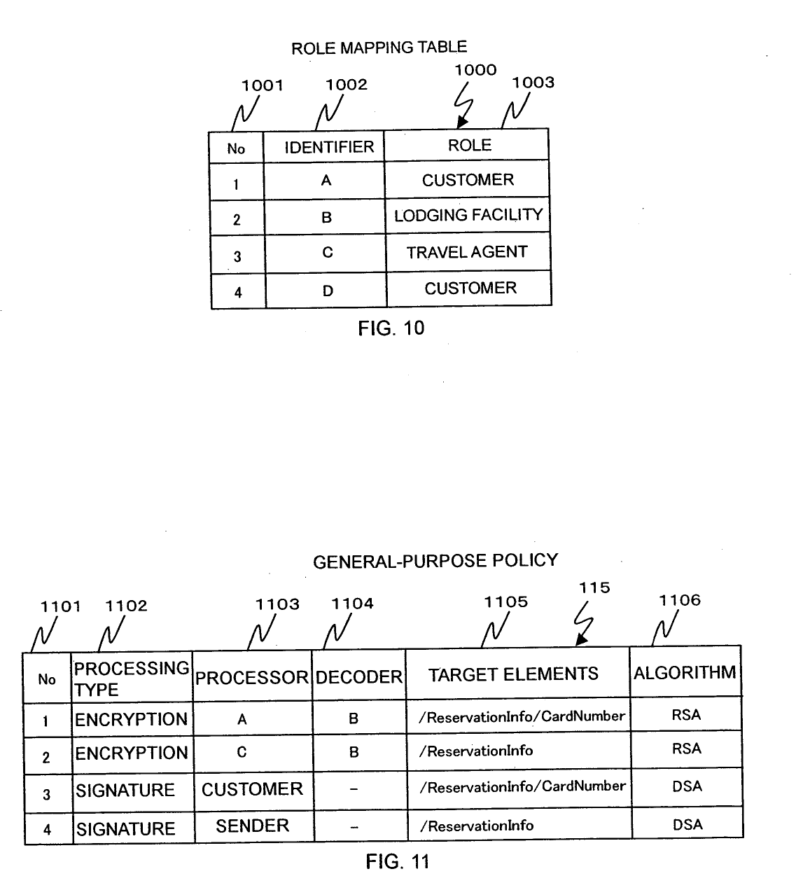

The second information processing apparatus 111 according to the second embodiment stores a roll mapping table, information indicating what kind of role each of the first information processing apparatuses 101 has. FIG. 10 shows an example of a role mapping table. In a No column 1001 of a role mapping table 1000, a line number is written. In an identifier column 1002, an identifier identifying an information processing apparatus is written. In a role column 1003, a role of that information processing apparatus is written.

Description will be given next of the processing for generating an individual policy from the general-purpose policy 115 shown in FIG. 11 when an individual policy request 500 shown in FIG. 5 is issued. It is to be noted that while the contents of the general-purpose policy 115 shown in FIG. 11 are basically the same as those of the general-purpose policy 115 shown in FIG. 6, the contents are different from those shown in FIG. 6 in that a role is written in a processor column 1103. When an individual policy is generated, the individual policy response unit 112 references the role mapping table 1000, acquiring a role (“Customer” in this case) corresponding to “A” written as the content of “Sender element” in the individual policy request 500. The individual policy response unit 112 recognizes that the first information processing apparatus 101, identified by “A”, has “Sender” as the role thereof from the fact that “A” is written as the content of “Sender element” in the individual policy request 500. That is, the individual policy response unit 112 recognizes, based on the written contents of the role mapping table 1000 and the individual policy request 500, that the first information processing apparatus 101 has two roles, i.e., “Customer” and “Sender.”

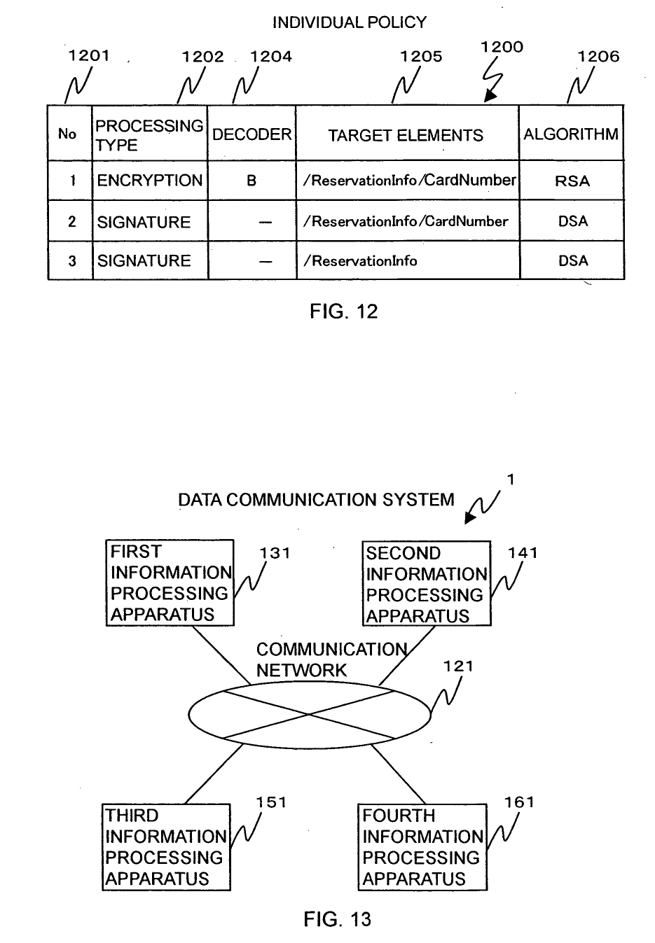

Next, the individual policy response unit 112 generates an individual policy from the general-purpose policy 115 based on the aforementioned two recognized roles. First, the individual policy response unit 112 extracts the policy expression with “A” written in the processor column 1103 from among the policy expressions included in the general-purpose policy 115. Next, the individual policy response unit 112 extracts the policy expression with “Customer” written in the processor column 1103. Further, the individual policy response unit 112 extracts the policy expression with “Sender” written in the processor column 1103. Then, the individual policy response unit 112 generates an individual policy using the contents of the policy expressions excluding the content of the processor column 1103. It is to be noted that FIG. 12 shows an individual policy generated in this manner.

According to the data communication system 1 of the second embodiment described above, individual policy request and general-purpose policies can be set using roles possessed by the respective information processing apparatuses—information intuitively easy to understand, allowing to set an individual policy request and a general-purpose policy more efficiently than when controlling the contents of an individual policy based on the identifiers of the information processing apparatuses. Therefore, this alleviates the burden of managing the security policies. Besides, failures to set the security policies or the erroneous settings of the security policies can be prevented because the roles are intuitive and easy to understand.

<Third Embodiment>

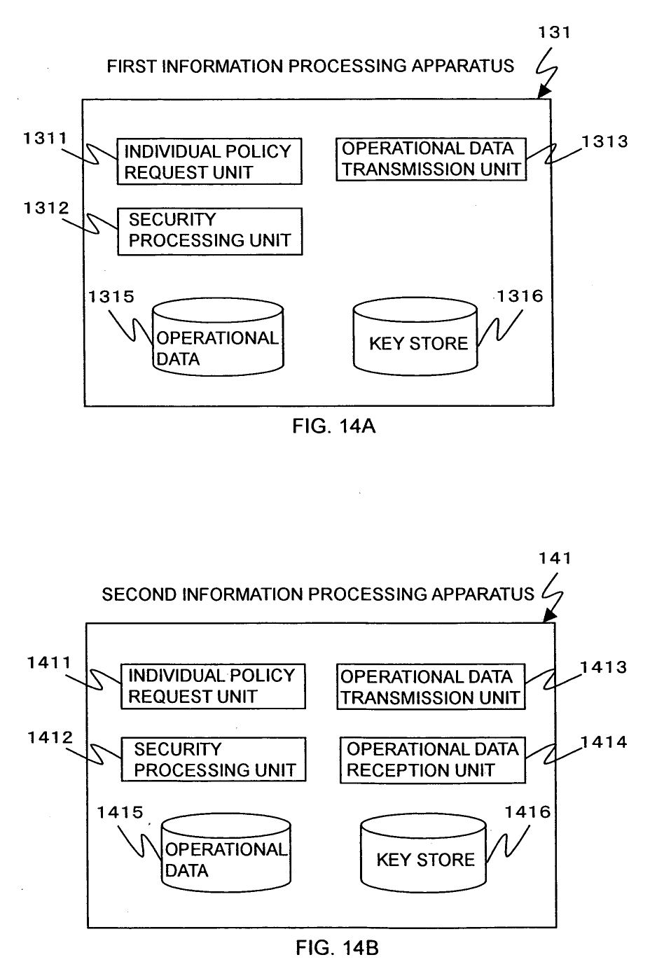

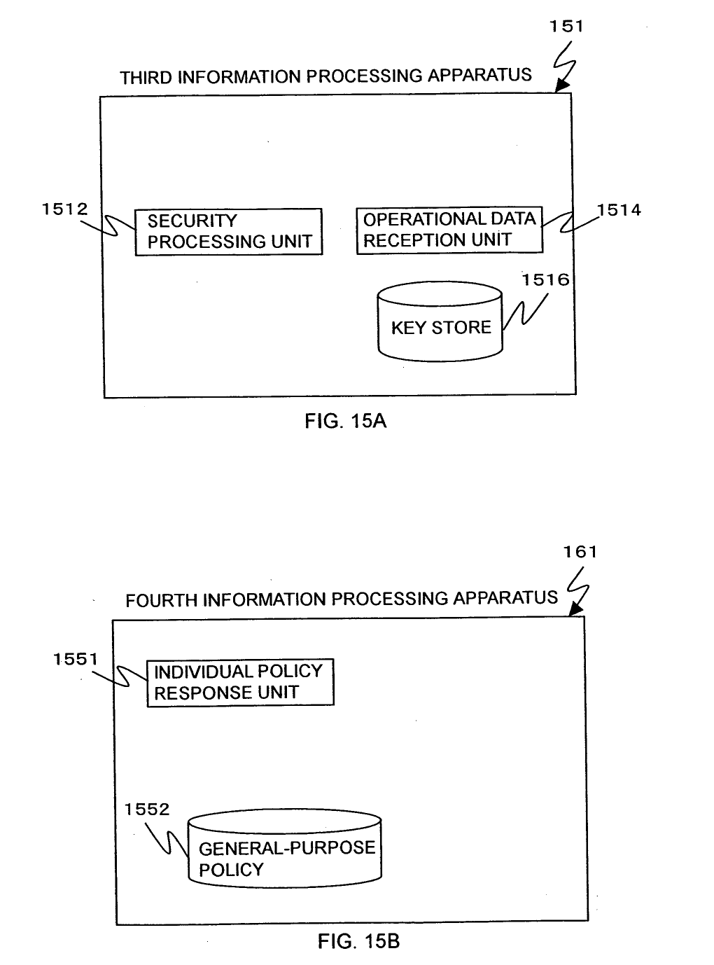

FIG. 13 shows an overall configuration of the data communication system 1 described as a third embodiment. First to fourth information processing apparatuses 131, 141, 151 and 161 are connected via the communication network 121 so as to be able to communicate with each other. The hardware configuration of the first to fourth information processing apparatuses 131, 141, 151 and 161 and the configuration of the communication network 121 are basically the same as those of the first embodiment. FIG. 14A shows the functions implemented and the data stored in the first information processing apparatus 131. The functions and the data are basically the same as those of the first information processing apparatus 101 according to the first embodiment described in FIG. 3A. FIG. 14B shows the functions implemented and the data stored in the second information processing apparatus 141. While being basically the same in configuration as the first information processing apparatus 101 according to the first embodiment described in FIG. 3B, the second information processing apparatus 141 according to the second embodiment differs from the first information processing apparatus 101 in that an operational data reception unit 1414 is provided for receiving operational data 1315 from the first information processing apparatus 131. FIG. 15A shows the functions implemented and the data stored in the third information processing apparatus 151. The configurations of a security processing unit 1512, an operational data reception unit 1514 and a key store 1516 are basically the same as those of the second information processing apparatus 111 according to the first embodiment described in FIG. 3B. FIG. 15B shows the functions implemented and the data stored in the fourth information processing apparatus 161. The configurations of an individual policy response unit 1551 and a general-purpose policy 1552 are basically the same as those of the second information processing apparatus 111 according to the first embodiment described in FIG. 3B.

The first information processing apparatus 131 transmits the operational data 1315 to the second information processing apparatus 141 via the communication network 121. The second information processing apparatus 141 transmits operational data 1415 received from the first information processing apparatus 131 to the third information processing apparatus 151 via the communication network 121. That is, in the data communication system 1 of the third embodiment, the operational data 1315 transmitted from the first information processing apparatus 131 is transmitted to the third information processing apparatus 151 by way of the second information processing apparatus 141. In the transmission of the operational data conducted in this manner, the first information processing apparatus 131 subjects, in conformity with the first individual policy, the operational data 1315 to be transmitted to the second information processing apparatus 141 to a security processing. On the other hand, the second information processing apparatus 141 subjects, in conformity with the second individual policy, the operational data 1415 to be transmitted to the third information processing apparatus 151 to a security processing. Then, the first information processing apparatus 131 transmits the first individual policy request to the fourth information processing apparatus 161 to obtain the first individual policy. On the other hand, the second information processing apparatus 141 transmits the second individual policy request to the fourth information processing apparatus 161 to obtain the second individual policy.

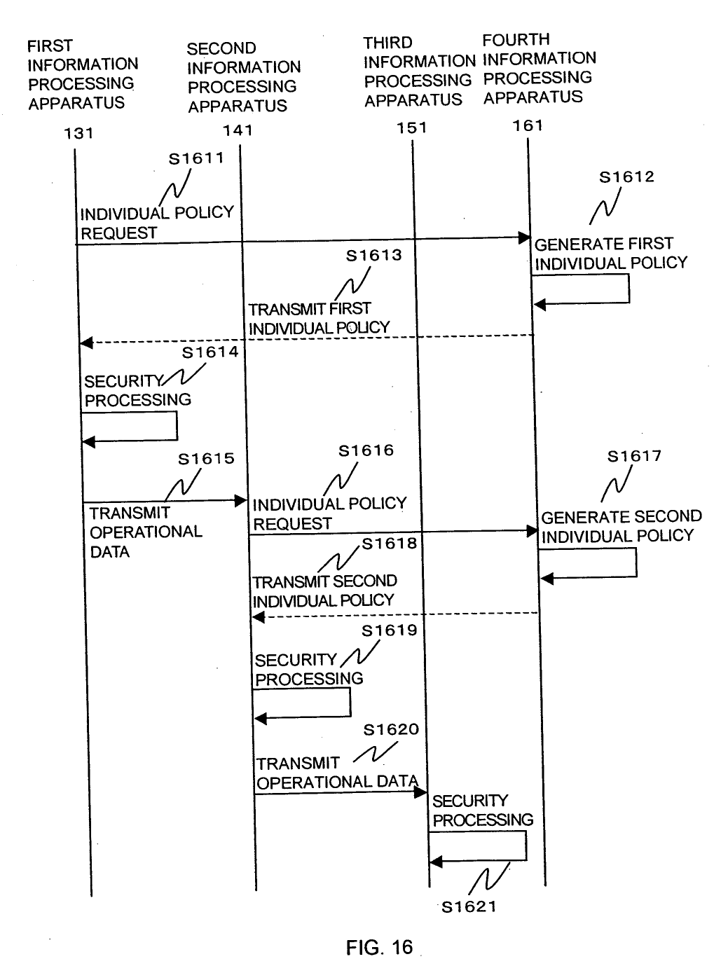

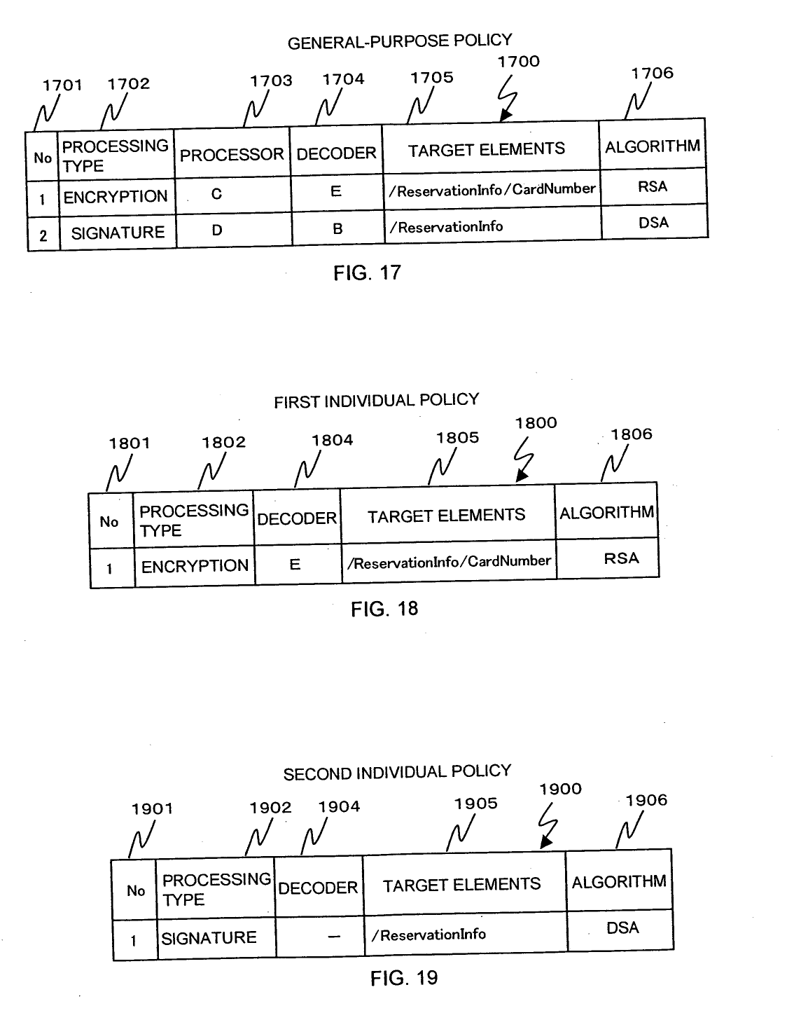

Description will be given next of the processings performed when the operational data 1315, transmitted from the first information processing apparatus 131, is transmitted to the third information processing apparatus 151 by way of the second information processing apparatus 141, with reference to the explanatory view of the processings shown in FIG. 16. First, an individual policy request unit 1311 of the first information processing apparatus 131 transmits the first individual policy request to the fourth information processing apparatus 161 (S1611). Here, it is assumed that the individual policy request 500 with the same contents as those shown in FIG. 5 is transmitted as the first individual policy request. Upon receiving the first individual policy request, the individual policy response unit 1551 of the fourth information processing apparatus 161 generates a first individual policy based on extractive information contained in the received first individual policy request and the general-purpose policy 1552 (S1612). FIG. 17 shows an example of the general-purpose policy 1552. On the other hand, FIG. 18 shows an example of the first individual policy generated based on the first individual policy request and the general-purpose policy 1552.

Upon generating the first individual policy, the fourth information processing apparatus 161 transmits this policy to the first information processing apparatus 131 (S1613). The first information processing apparatus 131 receives the first individual policy transmitted. Next, a security processing unit 1312 of the first information processing apparatus 131 subjects the operational data 1315 to a security processing based on the first individual policy (S1614). Then, an operational data transmission unit 1313 of the first information processing apparatus 131 transmits the operational data 1315 subjected to the security processing to the second information processing apparatus 141. The operational data reception unit 1414 of the second information processing apparatus 141 receives the operational data 1315 transmitted (S1615). It is to be noted that the received operational data 1315 is stored as the operational data 1415 in the second information processing apparatus 141.

Next, an individual policy request unit 1411 of the second information processing apparatus 141 transmits the second individual policy request to the fourth information processing apparatus 161 (S1616). Here, it is assumed that the individual policy request 500 with the same contents as those shown in FIG. 5 is transmitted as the second individual policy request. Upon receiving the second individual policy request, the individual policy response unit 1551 of the fourth information processing apparatus 161 generates a second individual policy based on extractive information contained in the received second individual policy request and the general-purpose policy 1552 (S1617). FIG. 19 shows an example of the second individual policy generated based on the second individual policy request and the general-purpose policy 1552.

Upon generating the second individual policy, the fourth information processing apparatus 161 transmits this policy to the second information processing apparatus 141 (S1618). The second information processing apparatus 141 receives the second individual policy transmitted. Next, the security processing unit 1412 of the second information processing apparatus 141 subjects the operational data 1415 to a security processing based on the second individual policy (S1619). An operational data transmission unit 1413 of the second information processing apparatus 141 transmits the operational data 1415 subjected to the security processing to the third information processing apparatus 151, resulting in the operational data 1415 being received by the operational data reception unit 1514 of the third information processing apparatus 151 (S1620). Then, the security processing unit 1512 of the third information processing apparatus 151 subjects the received operational data 1415 to a security processing such as decoding or signature verification using the key stored in the key store 1516 (S1621).

Thus, in the data communication system 1 of the third embodiment, the first and second information processing apparatuses 131 and 141 can each obtain an individual policy from the fourth information processing apparatus 161. This eliminates the needs to have ready an individual policy respectively in the first and second information processing apparatuses 131 and 141, allowing the first and second information processing apparatuses 131 and 141 to readily obtain individual policies by inquiring the fourth information processing apparatus 161 when necessary. This allows the first and second information processing apparatuses 131 and 141 to subject the operational data to a proper security processing.

In the data communication system 1 of the present embodiment, on the other hand, both the first individual policy, a policy applied to the operational data 1315 transmitted from the first information processing apparatus 131 to the second information processing apparatus 141, and the second individual policy, a policy applied to the operational data 1415 transmitted from the second information processing apparatus 141 to the third information processing apparatus 151, are obtained based on the common general-purpose policy managed in a unified manner by the fourth information processing apparatus 161. Therefore, even if a change is required to a security policy, changing the single general-purpose policy managed in a unified manner allows that change to be reflected throughout the entire data communication system 1. This allows readily ensuring consistent management of the security policies to be applied to the operational data in the data communication system 1 as a whole. This also contributes to a reduced burden of managing the security policies.

In a conventional data communication system, on the other hand, if the second and third information processing apparatuses 141 and 151 each request application of a security policy to the operational data transmitted, the first information processing apparatus 131 must obtain the security policy requested by each of the second and third information processing apparatuses 141 and 151 for the operational data 1315 to be transmitted to the second information processing apparatus 141. In the data communication system 1 of the present embodiment, however, the first information processing apparatus 131 needs only to obtain, from the fourth information processing apparatus 161, only the individual policy (first individual policy) required for transmission to the second information processing apparatus 141, alleviating the processing burden and the management burden on the first information processing apparatus 131.

As described above, on the other hand, the present embodiment is premised on the assumption that the operational data 1315 to be transmitted from the first information processing apparatus 131 to the second information processing apparatus 141 and the operational data 1415 transmitted from the second information processing apparatus 141 to the third information processing apparatus 151 are common in content to each other, with the contents of the general-purpose policy, managed by the fourth information processing apparatus 161, set assuming that the operational data is transmitted in this manner. This allows use of the common general-purpose policy for generating both the first and second individual policies.

It is to be noted that as a modification of the third embodiment, the individual policies may be generated by the first information processing apparatus 131 or the second information processing apparatus 141 as is down with the first embodiment. In this case, for example, the fourth information processing apparatus 161 transmits the general-purpose policy to the first information processing apparatus 131 or the second information processing apparatus 141 in response to a request, with extractive information stored in the first information processing apparatus 131 or the second information processing apparatus 141, thus allowing the security processing unit 1312 or 1412 to generate, based on the extractive information, the first or second individual policy from the general-purpose policy. This prevents an increase in the processing burden on the fourth information processing apparatus 161.

It is to be noted that the above description of the embodiments is intended to facilitate the understanding of the present invention and is not to be construed as a limitation thereof. The present invention may be modified or improved upon without departing from the spirit of the invention, and, needless to say, equivalents of the present invention are considered to be within the scope of the invention.

1. A control method of a data communication system performing data communication in conformity with a security policy, the data communication system including a first information processing apparatus with a first CPU and a first memory and a second information processing apparatus with a second CPU and a second memory connected to the first information processing apparatus so as to be able to communicate therewith, wherein the first information processing apparatus includes an individual policy request unit and a security processing unit implemented through execution of a program stored in the first memory by the first CPU, and wherein the second information processing apparatus includes an individual policy response unit implemented through execution of a program stored in the second memory by the second CPU, the control method comprising the steps of:
the second information processing apparatus storing a general-purpose policy including an individual policy that is a security policy applied to data transmitted from the first information processing apparatus to the second information processing apparatus;
the individual policy request unit transmitting to the second information processing apparatus an individual policy request including extractive information on the individual policy from the general-purpose policy;
the second information processing apparatus receiving the individual policy request;
the individual policy response unit generating the individual policy from the general-purpose policy based on the extractive information included in the received individual policy request;
the second information processing apparatus transmitting to the first information processing apparatus the individual policy generated by the individual policy response unit;
the first information processing apparatus receiving the individual policy; and
the security processing unit subjecting the data to a security processing in conformity with the received individual policy when the data is transmitted from the first information processing apparatus to the second information processing apparatus.

2. The control method of a data communication system of claim 1, wherein the individual policy request includes an identifier identifying the first information processing apparatus as the extractive information, wherein the general-purpose policy includes a security policy in correspondence with the identifier, and wherein the individual policy response unit generates the individual policy by extracting the security policy corresponding to the identifier.

3. The control method of a data communication system of claim 1, wherein the general-purpose policy includes a security policy to the effect that the data to be transmitted from the first information processing apparatus to the second information processing apparatus should be encrypted or signed, wherein the individual policy generated by the individual policy response unit includes a security policy to the effect that the encryption or signature should be conducted, and wherein the security processing unit encrypts or signs the data when the data is transmitted from the first information processing apparatus to the second information processing apparatus.

4. The control method of a data communication system of claim 3, wherein the general-purpose policy includes a security policy designating an algorithm used for the encryption or signature, wherein the individual policy generated by the individual policy response unit includes a security policy designating the algorithm, and wherein the security processing unit encrypts or signs the data depending on the algorithm when the data is transmitted from the first information processing apparatus to the second information processing apparatus.

5. The control method of a data communication system of claim 1, wherein the general-purpose policy includes a security policy to the effect that the data to be transmitted from the first information processing apparatus to the second information processing apparatus should be encrypted, wherein the general-purpose policy includes an identifier identifying the second information processing apparatus decoding the data, and wherein the security processing unit encrypts the data using a public key of the second information processing apparatus.

6. The control method of a data communication system of claim 1, wherein the individual policy request includes as the extractive information a role that is information indicating the role of the first information processing apparatus, wherein the general-purpose policy includes a security policy in correspondence with the role, and wherein the individual policy response unit generates the individual policy by extracting the security policy corresponding to the role.

7. The control method of a data communication system of claim 1, wherein the second information processing apparatus transmits the general-purpose policy to the first information processing apparatus in response to a request from the first information processing apparatus, and wherein the security processing unit generates the individual policy from the general-purpose policy based on extractive information stored therein and subjects the data to a security processing depending on the generated individual policy when the data is transmitted from the first information processing apparatus to the second information processing apparatus.

8. A control method of a data communication system performing data communication in conformity with a security policy, the data communication system including a first information processing apparatus with a first CPU and a first memory, a second information processing apparatus with a second CPU and a second memory connected to the first information processing apparatus so as to be able to communicate therewith, a third information processing apparatus with a third CPU and a third memory connected to the first and second information processing apparatuses so as to be able to communicate therewith, and a fourth information processing apparatus with a fourth CPU and a fourth memory connected to the first and second information processing apparatuses so as to be able to communicate therewith, the first information processing apparatus having a first individual policy request unit and a first security processing unit implemented through execution of a program stored in the first memory by the first CPU, the second information processing apparatus having a second individual policy request unit and a second security processing unit implemented through execution of a program stored in the second memory by the second CPU, the fourth information processing apparatus having an individual policy response unit implemented through execution of a program stored in the fourth memory by the fourth CPU,
wherein the fourth information processing apparatus stores a general-purpose policy including a first individual policy that is a security policy applied to data transmitted from the first information processing apparatus to the second information processing apparatus and a second individual policy that is a security policy applied to data transmitted from the second information processing apparatus to the third information processing apparatus,
wherein the first individual policy request unit transmits to the fourth information processing apparatus a first individual policy request including first extractive information that is extractive information on the first individual policy from the general-purpose policy,
wherein the second individual policy request unit transmits to the fourth information processing apparatus a second individual policy request including second extractive information that is extractive information on the second individual policy from the general-purpose policy,
wherein the fourth information processing apparatus receives the first individual policy request,
wherein the fourth information processing apparatus receives the second individual policy request,
wherein the individual policy response unit generates the first individual policy from the general-purpose policy based on the first extractive information included in the received individual policy request,
wherein the individual policy response unit generates the second individual policy from the general-purpose policy based on the second extractive information included in the received individual policy request,
wherein the fourth information processing apparatus transmits the first individual policy generated by the individual policy response unit to the first information processing apparatus,
wherein the fourth information processing apparatus transmits the second individual policy generated by the individual policy response unit to the second information processing apparatus,
wherein the first information processing apparatus receives the first individual policy,
wherein the second information processing apparatus receives the second individual policy,
wherein the first security processing unit subjects the data to a security processing depending on the received first individual policy when the data is transmitted from the first information processing apparatus to the second information processing apparatus, and
wherein the second security processing unit subjects the data to a security processing depending on the received second individual policy when the data is transmitted from the second information processing apparatus to the third information processing apparatus.

9. A data communication system performing data communication in conformity with a security policy, the data communication system comprising a first information processing apparatus with a first CPU and a first memory and a second information processing apparatus with a second CPU and a second memory connected to the first information processing apparatus so as to be able to communicate therewith,
wherein the first information processing apparatus includes an individual policy request unit and a security processing unit implemented through execution of a program stored in the first memory by the first CPU,
wherein the second information processing apparatus includes an individual policy response unit implemented through execution of a program stored in the second memory by the second CPU,
wherein the second information processing apparatus stores a general-purpose policy including an individual policy that is a security policy applied to data transmitted from the first information processing apparatus to the second information processing apparatus,
wherein the individual policy request unit transmits to the second information processing apparatus an individual policy request including extractive information on the individual policy from the general-purpose policy,
wherein the second information processing apparatus receives the individual policy request,
wherein the individual policy response unit generates the individual policy from the general-purpose policy based on the extractive information included in the received individual policy request,
wherein the second information processing apparatus transmits to the first information processing apparatus the individual policy generated by the individual policy response unit,
wherein the first information processing apparatus receives the individual policy, and
wherein the security processing unit subjects the data to a security processing depending on the received individual policy when the data is transmitted from the first information processing apparatus to the second information processing apparatus.

10. An information processing apparatus for use as the second information processing apparatus in the data communication system of claim 9, the information processing apparatus having the second CPU and the second memory, the information processing apparatus being connected to the first information processing apparatus so as to be able to communicate therewith, the information processing apparatus comprising the individual policy response unit implemented through execution of a program stored in the second memory by the second CPU,
wherein the information processing apparatus stores a general-purpose policy including an individual policy that is a security policy applied to data transmitted from the first information processing apparatus to the second information processing apparatus,
wherein the information processing apparatus receives the individual policy request transmitted from the first information processing apparatus,
wherein the individual policy response unit generates the individual policy from the general-purpose policy based on the extractive information included in the received individual policy request, and
wherein the information processing apparatus transmits the individual policy generated by the individual policy response unit to the first information processing apparatus.

11. A data communication system performing data communication in conformity with a security policy, the data communication system comprising a first information processing apparatus with a first CPU and a first memory, a second information processing apparatus with a second CPU and a second memory connected to the first information processing apparatus so as to be able to communicate therewith, a third information processing apparatus with a third CPU and a third memory connected to the first and second information processing apparatuses so as to be able to communicate therewith, and a fourth information processing apparatus with a fourth CPU and a fourth memory connected to the first and second information processing apparatuses so as to be able to communicate therewith,
wherein the first information processing apparatus includes a first individual policy request unit and a first security processing unit implemented through execution of a program stored in the first memory by the first CPU,
wherein the second information processing apparatus includes a second individual policy request unit and a second security processing unit implemented through execution of a program stored in the second memory by the second CPU,
wherein the fourth information processing apparatus includes an individual policy response unit implemented through execution of a program stored in the fourth memory by the fourth CPU,
wherein the fourth information processing apparatus stores a general-purpose policy, the general-purpose policy including a first individual policy that is a security policy applied to data transmitted from the first information processing apparatus to the second information processing apparatus and a second individual policy that is a security policy applied to data transmitted from the second information processing apparatus to a third information processing apparatus,
wherein the first individual policy request unit transmits to the fourth information processing apparatus a first individual policy request including first extractive information that is extractive information on the first individual policy from the general-purpose policy,
wherein the second individual policy request unit transmits to the fourth information processing apparatus a second individual policy request including second extractive information that is extractive information on the second individual policy from the general-purpose policy,
wherein the fourth information processing apparatus receives the first individual policy request,
wherein the fourth information processing apparatus receives the second individual policy request,
wherein the individual policy response unit generates the first individual policy from the general-purpose policy based on the first extractive information included in the received individual policy request,
wherein the individual policy response unit generates the second individual policy from the general-purpose policy based on the second extractive information included in the received individual policy request,
wherein the fourth information processing apparatus transmits the first individual policy generated by the individual policy response unit to the first information processing apparatus,
wherein the fourth information processing apparatus transmits the second individual policy generated by the individual policy response unit to the second information processing apparatus,
wherein the first information processing apparatus receives the first individual policy,
wherein the second information processing apparatus receives the second individual policy,
wherein the first security processing unit subjects the data to a security processing depending on the received first individual policy when the data is transmitted from the first information processing apparatus to the second information processing apparatus, and
wherein the second security processing unit subjects the data to a security processing depending on the received second individual policy when the data is transmitted from the second information processing apparatus to the third information processing apparatus.

12. An information processing apparatus for use as the fourth information processing apparatus in the data communication system of claim 11, the information processing apparatus having the fourth CPU and the fourth memory and being connected to the first and second information processing apparatuses so as to be able to communicate therewith, the information processing apparatus comprising the individual policy response unit implemented through execution of a program stored in the fourth memory by the fourth CPU,
wherein the information processing apparatus stores a general-purpose policy, the general-purpose policy including a first individual policy that is a security policy applied to data transmitted from the first information processing apparatus to the second information processing apparatus and a second individual policy that is a security policy applied to data transmitted from the second information processing apparatus to a third information processing apparatus,
wherein the information processing apparatus receives the first individual policy request,
wherein the information processing apparatus receives the second individual policy request,
wherein the individual policy response unit generates the first individual policy from the general-purpose policy based on the first extractive information included in the received individual policy request,
wherein the individual policy response unit generates the second individual policy from the general-purpose policy based on the second extractive information included in the received individual policy request,
wherein the information processing apparatus transmits the first individual policy generated by the individual policy response unit to the first information processing apparatus, and
wherein the information processing apparatus transmits the second individual policy generated by the individual policy response unit to the second information processing apparatus.
